(19) United States
(12) Patent Application Publication
(10) Pub. No.: US 2010/0079659 A1
(43) Pub. Date: Apr. 1, 2010

(54) IMAGE CAPTURING APPARATUS, IMAGE CAPTURING METHOD, AND COMPUTER READABLE MEDIUM

(75) Inventor: Shuji ONO, Kanagawa (JP)

Correspondence Address: BIRCH STEWART KOLASCH & BIRCH, PO BOX 747, FALLS CHURCH, VA, 22040-0747, US

(73) Assignee: FUJIFILM Corporation, Tokyo (JP)

(21) Appl. No.: 12/569,223

(22) Filed: Sep. 29, 2009

(30) Foreign Application Priority Data
Sep. 30, 2008 (JP) 2008-254942

(51) Int. Cl. H04N 5/232

(52) U.S. Cl. 348/345; 348/E05.045

(57) ABSTRACT

Provided is an image capturing apparatus comprising an image capturing section; an optical system that has an optical transfer characteristic that remains substantially constant with regard to distance to an object point due to modulation of a wavefront of light from the object point, and that modulates the wavefront of the light from the object point to have a different slope according to the distance to the object point; a control section that controls an imaging characteristic of the optical system by controlling an optical characteristic of the optical system; and a position identifying section that identifies a subject distance, which is distance to a subject, based on a position of an object representing the same subject in a first image and a second image, which are respectively captured when the control section controls optical system to have different imaging characteristics.

### CROSS REFERENCE TO RELATED APPLICATION

The present application claims priority from Japanese Patent Application No. 2008-254942 filed on Sep. 30, 2008, the contents of which are incorporated herein by reference.

### BACKGROUND

1. Technical Field

The present invention relates to an image capturing apparatus, an image capturing method, and a computer readable medium.

2. Related Art

A technique for using a phase plate having a 3-dimensional curved surface to hold an optical transfer function of an optical system substantially constant within a range set by a focal position is known, as in, for example, Japanese Patent Application Publication No. 2006-94469 and Japanese Unexamined Patent Application Publication No. 11-500235.

With this technique, however, the subject of the image capturing becomes blurred, and therefore the distance to the subject cannot be measured using contrast detection. The invention disclosed in JP 2006-94469 measures the subject distance using an external active technique, but this requires that a separate distance measuring device be provided.

### SUMMARY

Therefore, it is an object of an aspect of the innovations herein to provide an image capturing apparatus, an image capturing method, and a computer readable medium, which are capable of overcoming the above drawbacks accompanying the related art. The above and other objects can be achieved by combinations described in the independent claims. The dependent claims define further advantageous and exemplary combinations of the innovations herein.

According to a first aspect related to the innovations herein, one exemplary image capturing apparatus may comprise an image capturing section; an optical system that has an optical transfer characteristic that remains substantially constant with regard to distance to an object point due to modulation of a wavefront of light from the object point, and that modulates the wavefront of the light from the object point to have a different slope according to the distance to the object point; a control section that controls an imaging characteristic of the optical system by controlling an optical characteristic of the optical system; and a position identifying section that identifies a subject distance, which is distance to a subject, based on a position of an object representing the same subject in a first image and a second image, which are respectively captured when the control section controls optical system to have different imaging characteristics.

According to a second aspect related to the innovations herein, one exemplary image capturing method may comprise capturing an image through an optical system that has an optical transfer characteristic that remains substantially constant with regard to distance to an object point due to modulation of a wavefront of light from the object point, and that modulates the wavefront of the light from the object point to have a different slope according to the distance to the object point; controlling an imaging characteristic of the optical system by controlling an optical characteristic of the optical system; and identifying a subject distance, which is distance to a subject, based on a position of an object representing the same subject in a first image and in a second image, which are respectively captured when the control section controls optical system to have different imaging characteristics.

According to a third aspect related to the innovations herein, one exemplary computer readable medium may include a computer readable medium storing thereon a program for use by an image capturing apparatus, the program causing the computer to function as an image capturing section capturing an image through an optical system that has an optical transfer characteristic that remains substantially cons ant with regard to distance to an object point due to modulation of a wavefront of light from the object point, and that modulates the wavefront of the light from the object point to have a different slope according to the distance to the object point; a control section that controls an imaging characteristic of the optical system by controlling an optical characteristic of the optical system; and a position identifying section that identifies a subject distance, which is distance to a subject, based on a position of an object representing the same subject in a first image and a second image, which are respectively captured when the control section controls optical system to have different imaging characteristics.

The summary clause does not necessarily describe all necessary features of the embodiments of the present invention. The present invention may also be a sub-combination of the features described above. The above and other features and advantages of the present invention will become more apparent from the following description of the embodiments taken in conjunction with the accompanying drawings.

### BRIEF DESCRIPTION OF THE DRAWINGS

FIG. 1 shows an exemplary configuration of an image capturing apparatus 110 according to an embodiment of the present invention.

FIG. 2 shows exemplary phase distributions of the pupil surface according to the defocus.

FIG. 3 shows an exemplary change in the defocus amount.

FIG. 4A shows a dependency relation exhibited by the shift amount of the imaging position with respect to the positional shift of the optical system 100.

FIG. 4B shows an exemplary shift of the imaging position.

FIG. 5A shows another dependency relation exhibited by the shift amount of the imaging position with respect to the positional shift of the optical system 100.

FIG. 5B shows another exemplary shift of the imaging position.

FIG. 6 is a data table showing an example of data stored by the image processing parameter storing section 188.

FIG. 7 shows an exemplary hardware configuration of a hardware configuration of a computer functioning as the image capturing apparatus 110.

### DESCRIPTION OF EXEMPLARY EMBODIMENTS

Hereinafter, some embodiments of the present invention will be described. The embodiments do not limit the invention according to the claims, and all the combinations of the features described in the embodiments are not necessarily essential to means provided by aspects of the invention.

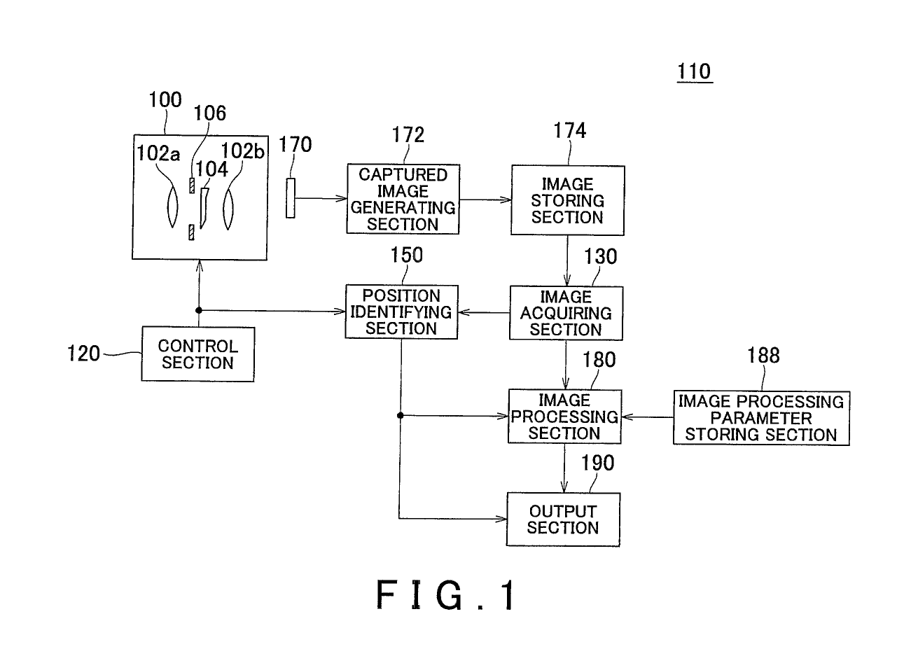

FIG. 1 shows an exemplary configuration of an image capturing apparatus 110 according to an embodiment of the present invention. The image capturing apparatus 110 can calculate distance to a subject. The image capturing apparatus 110 may be a digital still camera, a cellular phone with an image capturing function, a surveillance camera, an endoscope, or any of a variety of other types of image capturing devices.

The image capturing apparatus 110 is provided with an optical system 100, a light receiving section 170, a captured image generating section 172, an image storing section 174, an image acquiring section 130, an image processing section 180, an image processing parameter storing section 188, a position identifying section 150, an output section 190, and a control section 120. The optical system 100 includes a plurality of imaging lenses 102a and 102b, a light modulating section 104, and a diaphragm section 106. Hereinafter, the imaging lenses 102a and b are referred to collectively as the “imaging lenses 102.” In the present embodiment, the entire optical system 100 has a shape that is non-rotationally symmetric with respect to the optical axis.

The diaphragm section 106 restricts light from the subject passing through the optical system 100. In the example of FIG. 1, the diaphragm section 106 is provided between the imaging lenses 102 and the light modulating section 104. In other configurations, the diaphragm section 106 may be provided between the subject and at least one of the imaging lenses 102 and the light modulating section 104, or may be provided between the light receiving section 170 and at least one of the imaging lenses 102 and the light modulating section 104.

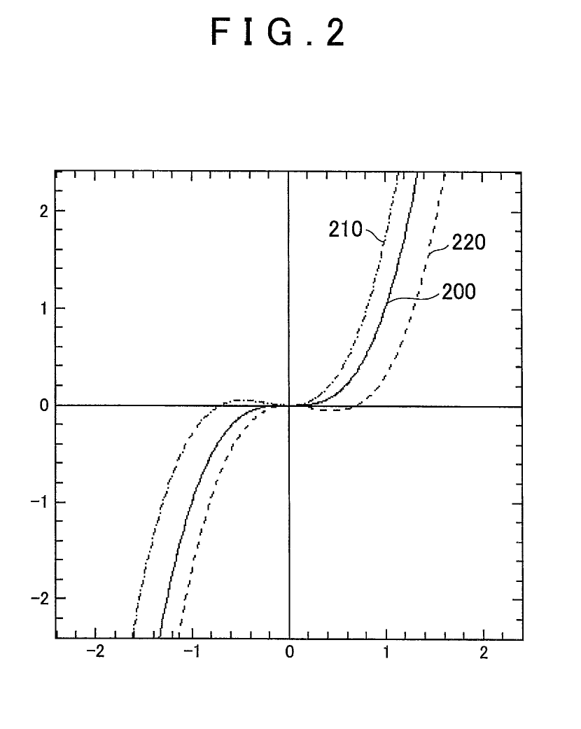

The optical system 100 holds the spread of light from an object point relatively constant over varying distances to the object point by causing the light modulating section 104 to perform wavefront modulation on the light. The optical characteristics of the light modulating section 104 are described further below in relation to FIG. 2. By modulating the wavefront of the light from the object point in this way, the optical system 100 causes the optical transfer characteristic to remain substantially constant with respect to the distance of the object point and causes the wavefront of the light from the object point to have a different slope depending on the distance of the object point. An explanation of the optical system 100 forming an image at a position corresponding to a defocus amount is provided further below in relation to FIG. 2.

The control section 120 controls the defocus amount by controlling the optical characteristics of the optical system 100. The defocus amount is one example of an imaging characteristic. The control section 120 can also control the optical transfer characteristic of the optical system 100. More specifically, the control section 120 can control the defocus amount by controlling at least one of the position of the optical system 100 and the degree to which the diaphragm section 106 opens. The control section 120 may control the optical characteristics of the optical system 100 by controlling the focal distance of the optical system 100. The focal distance of the optical system 100 may be the focal distance of the imaging lenses 102.

The light receiving section 170 receives light from the subject that passes through the optical system 100. The light receiving section 170 includes a plurality of image capturing elements that are arranged 2-dimensionally on a surface that is perpendicular to the optical axis of the optical system 100. The plurality of image capturing elements each receive light passed through the optical system 100.

The image capturing elements of the light receiving section 170 may be CCD image capturing elements or may be CMOS image capturing elements. An image capture signal that indicates the amount of light received by each image capturing element is supplied to the captured image generating section 172.

The captured image generating section 172 generates images based on captured image signals. The captured image generating section 172 generates a digital image by performing an AD conversion on the captured image signal from each image capturing element. The light receiving section 170 and the captured image generating section 172 function as the image capturing section in the present invention.

The image storing section 174 stores the images generated by the captured image generating section 172. The image storing section 174 may include a storage element such as a semiconductor memory or a magnetic memory. The image storing section 174 may include volatile storage elements or non-volatile storage elements. The image storing section 174 may store the images generated by the captured image generating section 172 in the storage element.

The image acquiring section 130 acquires the images stored in the image storing section 174. More specifically, the image acquiring section 130 acquires a first image and a second image, which are captured at different defocus amounts under the control of the control section 120. The images acquired by the image acquiring section 130 are supplied to the position identifying section 150 and the image processing section 180. The position identifying section 150 identifies the subject distance, which is the distance to the subject, based on the positions of objects representing the same subject in the first image and the second image captured at different defocus amounts under the control of the control section 120.

The image processing section 180 generates a corrected image by applying a correction process for correcting point image spread caused by the optical system 100 in the image, based on the optical transfer characteristic of the optical system 100. For example, the image processing section 180 may generate the corrected image by applying to the image an inverse filter based on the optical characteristic of the optical system 100. The image processing section 180 may apply the correction process according to the subject distance identified by the position identifying section 150.

The output section 190 outputs the corrected image generated by the image processing section 180. For example, the output section 190 may output the corrected image to a recording medium storing the image. The output section 190 may output the corrected image to the outside of the image capturing apparatus 110. For example, the output section 190 may output the corrected image to an output device such as a personal computer, a printer, or a display.

The image processing parameter storing section 188 stores an image processing parameter used for the correction process applied to the image, in association with the imaging characteristics of the optical system 100. This image processing parameter is exemplified by the inverse filter described above in the present embodiment. The image processing section 180 applies the correction process to the image using the image processing parameter stored by the image processing parameter storing section 188 in association with the imaging characteristic that substantially matches the imaging characteristic set by the control section 120.

The image acquiring section 130, the position identifying section 150, the image processing section 180, the image processing parameter storing section 188, and the output section 190 may be provided to an image processing apparatus that is separate from the image capturing apparatus 110. This image processing apparatus can apply the correction process described above by acquiring the captured images from the image capturing apparatus 110. This image processing apparatus may be exemplified as an electronic information processing apparatus such as a personal computer.

FIG. 2 shows exemplary phase distributions of the lens surface according to the defocus. The phase distribution in FIG. 2 represents a phase distribution caused by the light modulating section 104 having a curved surface expressed by a third-order expression where each value is a coordinate in a coordinate system associated with an orthogonal coordinate system having the optical axis as the point of origin. More specifically, when the two axes orthogonal to the optical axis of the optical system 100 are x and y, the wavefront aberration caused by the light modulating section 104 is proportional to (x³+y³).

Here, the defocus effect caused by the imaging lenses 102 is added to the phase distribution caused by the optical system 100 including the light modulating section 104 and the imaging lenses 102. The 1-dimensional phase distribution φ(x) caused by the entirety of the optical system 100 can be expressed as φ(x)=x³+dx² when the defocus amount is d. In this way, the optical system 100 approximates the phase distribution of light from the object point with a polynomial function of an order greater than the two, which corresponds to the position relative to the optical axis. By converting the wavefront of the light from the object point into a wavefront having this phase distribution, the optical system 100 can keep the light from the object point at a substantially constant spread, regardless of the distance to the object point.

Here, the phase distribution φ(x) can be transformed to the expression φ(x)=(x+d/3)³−(d²/3)x−d³/27. The first term in this transformed expression represents a positional shift of the entire light modulating section 104, and this term has a relatively small effect on the imaging. The second term represents the slope of the wavefront, and the effect of this term manifests as a shift in the imaging position. The third term represents the phase shift of a constant, and does not affect the imaging characteristic. In this way, the optical system 100 causes a shift in the imaging position according to the defocus amount.

The phase distribution 200 in FIG. 2 represents the phase distribution when the defocus amount is 0. The phase distribution 210 and the phase distribution 220 represent the phase distribution when the defocus amount is positive and negative, respectively. Based on the phase distribution 210, it is understood that the slope becomes negative in a region where the x-value near the point of origin is negative. Furthermore, concerning the width of the shift in the x-direction, i.e. the absolute value of the difference in the x-coordinates at which the phase difference takes the same value, between the phase distribution 210 and the phase distribution 200, this shift width is less in the region where x is positive than in the region where x is negative. Therefore, the overall shape of the phase distribution 210 is seen as being similar to that of the phase distribution 200 slanted in a negative direction.

In the same way, the overall shape of the phase distribution 220 is seen as being similar to that of the phase distribution 200 slanted in a negative direction. Therefore, it is understood that the optical system 100 modulates the wavefront of the light from the object point with a different slope according to the distance to the object point. This slope according to the defocus amount affects the imaging position in the image.

In this way, the optical system 100 can approximate the phase distribution of light from the object point with a polynomial function having a second-order term expressing the phase distribution according to the defocus amount. More specifically, the optical system 100 may approximate the phase distribution of light from the object point with a polynomial function having a second-order term according to the defocus amount and an odd-order term with an order greater than or equal to 3. Yet more specifically, the optical system 100 may approximate the phase distribution of light from the object point with a polynomial function having a second-order term according to the defocus amount and a third-order term. Furthermore, the optical system 100 may approximate the phase distribution of light from the object point with a polynomial function having a second-order term according to the defocus amount of the imaging lenses 102 and an odd-order term having order greater than or equal to 3 according to the phase modulation of the light modulating section 104.

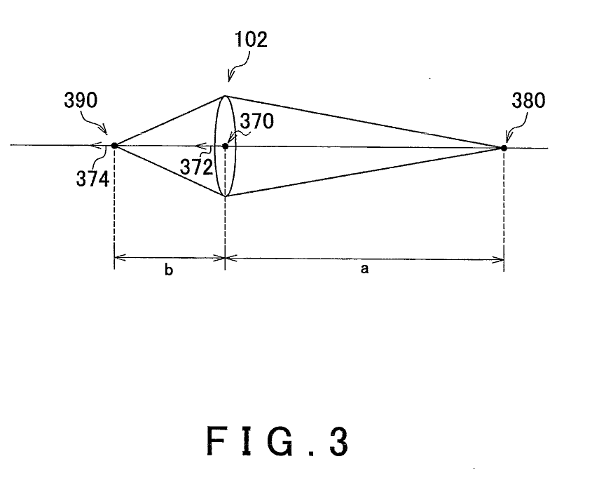

FIG. 3 shows an exemplary change in the defocus amount. The light from a position 380 of the object point on the optical axis is focused by the imaging lenses 102 to form an image at the image position 390, which is the point of intersection between the focal surface and the optical axis. When the position 380 of the object point is changed on the optical axis, the image position 390 also changes, and this causes change in the defocus amount d. Here, when the control section 120 moves the position 370 of the principal point of the imaging lenses 102 in a direction of the arrow 372, the image position 390 move moves in the direction of the arrow 374. By controlling the position 370 of the principal point of the imaging lenses 102 to control the image position 390, the control section 120 can change the defocus amount d. As another example, the control section 120 may control the focus amount d by controlling the focal distance of the imaging lenses 102.

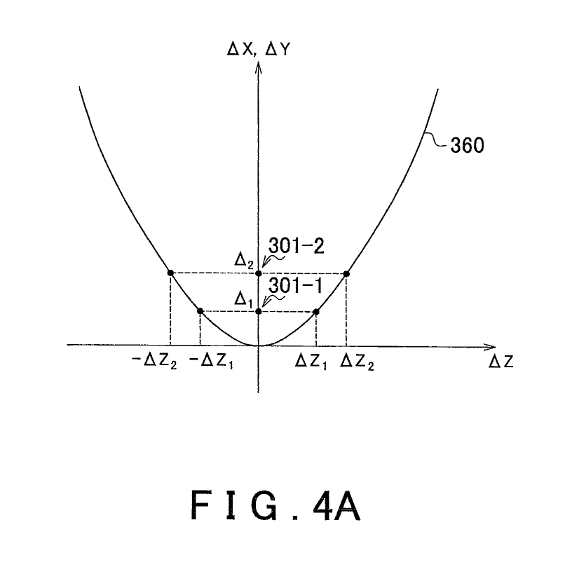

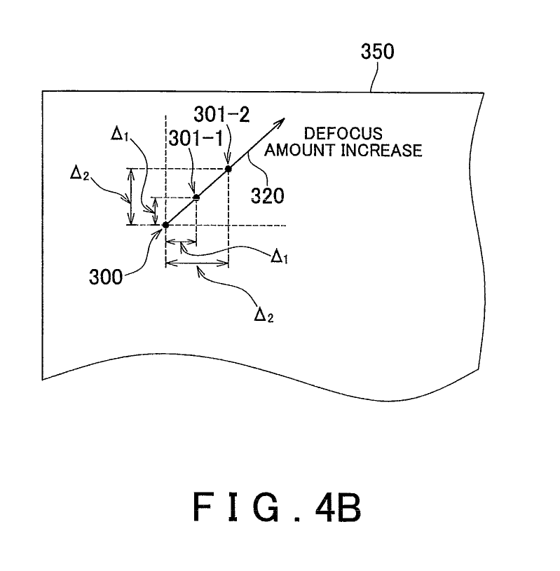

FIG. 4A shows a dependency relation exhibited by the shift amount of the imaging position with respect to the positional shift of the optical system 100. In the graph of FIG. 4A, the horizontal axis represents a position of the optical system 100 on the optical axis, and Δz is the positional shift of the optical system 100 caused by the control section 120. Here, the defocus amount d is set equal to 0 when the optical system 100 is controlled to be at the position Δz=0. The positional shift is the shift of the position at which the actual image is formed from the position at which the image was supposed to be formed. Here, the “position at which the image was supposed to be formed” may be the imaging point when the diaphragm section 106 is controlled to have the minimum opening. When the control section 120 controls the diaphragm section 106 to have the maximum opening, the wavefront modulation effect occurs due to the light modulating section 104 because light passes through a region that is not near the optical axis of the light modulating section 104, and therefore the imaging position shifts according to the defocus amount.

The line 360 shows the dependency of positional shift amounts Δx and Δy on Δz. As described above, the positional shift is caused by the coefficient of the second term, −d²/3, in the transformed φ(x) expression. Accordingly, the positional shift on the x-axis depends on the value of d². In the same way, the positional shift on the y-axis also depends on the defocus amount d². If the focal distance of the imaging lenses 102 is fixed, the distance “a” shown in FIG. 3 from the object point to the imaging lenses 102 is significantly greater than the distance “b” from the imaging lenses 102 to the imagining point, and therefore Δz is approximately equal to d. Accordingly, the positional shift amount Δ has a dependency on Δz that follows a quadratic curve, such as shown by the line 360.

More specifically, when the control section 120 controls the value of Δz to be Δz₁ or −Δz₁, the positional shift values Δx and Δy are equal to 1. In this case, the light from the object point focuses at a corresponding position 301-1 described further below in relation to FIG. 4B. When the control section 120 controls the value of Δz to be Δz₂ or −Δz₂, the positional shift values Δx and Δy are equal to 2. In this case, the light from the object point focuses at a corresponding position 301-2 described further below in relation to FIG. 4B.

FIG. 4B shows an exemplary shift of the imaging position. In the captured image 350, when the image is captured while the diaphragm section 106 has the minimum opening, the lift from a certain object point focuses at the position 300 of the image 350. Since the wavefront of light that has passed through the region near the optical axis is not substantially modulated by the light modulating section 104, the imaging effect caused by the imaging lenses 102 remains as the imaging result of the optical system 100 when the diaphragm section 106 has the minimum opening. Therefore, the light from the object point focuses at the position 300.

On the other hand, when an image is captured while the diaphragm section 106 has the maximum opening, the light from the object point forms an image with blur at the specific position 300 when the defocus amount is 0. As the absolute value of the defocus amount d increases, the light from the object point forms an image with blur at a position 320 further separated in a specific direction from the specific position 300.

For example, assume that the light from a certain subject forms an image at the position 300 when the diaphragm section 106 has the minimum opening. When an image of this subject is captured while the diaphragm section 106 has the maximum opening, the light from the subject forms an image at the position 301-1. In this case, the position identifying section 150 can calculate the absolute value of the defocus d based on the positional shift amount Δ from the position 300. For example, the position identifying section 150 may store in advance a dependency exhibited by the defocus amount d on the shift amount Δ, such as shown by the line 360 in FIG. 4. In this way, the position identifying section 150 can calculate the defocus amount d based on the shift amount Δ.

As described in relation to FIG. 4A, the positional shift amount Δ depends on the absolute value of the defocus amount d, and therefore the distance to the subject cannot be accurately calculated merely based on the defocus amount d. For example, if the positional shift Δ is sufficiently less than a prescribed threshold value so as to be substantially ignorable, the position identifying section 150 can identify the subject distance as being the distance “a,” which corresponds to the distance “b” and the focal distance, by using the focal distance and the relation shown in FIG. 3. On the other hand, if the positional shift amount Δ is too large to be ignored, the position identifying section 150 cannot identify whether the subject is farther from or closer to the optical system 100 than the imaging position of the imaging optical elements included in the imaging system 100.

Whether the subject is closer to or farther from the optical system 100 can be determined by detecting a difference in the positional shift amount when Δz is controlled to have different values, as described hereinafter. For example, consider a situation in which the control section 120 changes the position of the optical system 100 in a direction that greatly increases Δz. In this case, it is assumed that the light from the same subject forms an image at the position 301-2. With reference to FIG. 4A, the imaging position moving from position 301-1 to position 301-2 when Δz is increased, such that the imaging position moves away from the position 300, corresponds to Δz changing from Δz₁ to Δz₂. Therefore, since the sign of the focus amount d is known, the position identifying section 150 can calculate the distance of the subject based on the defocus amount d.

More specifically, the position identifying section 150 may store in advance a function for the subject distance that has, as variables, a difference in Δz and a difference in the positional shift amount Δ. Here, in the above example, the difference in Δz is Δz₂−Δz₁, and the difference in the positional shift is Δ₂−Δ₁. The position identifying section 150 can calculate the subject distance using the above function, the value of Δz₂−Δz₁, and the value of Δ₂−Δ₁. As shown by the line 360, the dependency of the positional shift amount Δ with respect to Δz follows a U-shaped curve. Therefore, by capturing two images with different Δz values, the subject distance Z can be calculated based on the difference in Δz and the difference in the shift amount Δ between the two images. Furthermore, by capturing three or more images with different Δz values, the subject distance can be calculated more accurately.

In this way, the position identifying section 150 can identify the subject distance based on an object distance, which is the difference between a position of an object in the first image and a position of the object in the second image. In this case, the control section 120 may control the defocus amount by controlling the diaphragm section 106 to have an opening that causes the phase modulation by the light modulating section 104 and the aberration by the imaging lenses 102 to be less than a predetermined value, and then controlling the diaphragm section 106 to have an opening that is larger than the above opening. For example, the first image may be captured while the diaphragm section 106 has the minimum opening, which causes the phase modulation by the light modulating section 104 and the aberration by the imaging lenses 102 to be less than a predetermined value, and the second image may be captured while the diaphragm section 106 has the maximum opening.

Since the second image is blurred, the image processing section 180 may correct the second image according to the optical transfer characteristic of the optical system 100 when the second image was captured. The position identifying section 150 may then identify the subject distance based on the corrected image, which is the second image corrected by the image processing section 180, and the position of an object corresponding to the subject in the second image. The position identifying section 150 may identify the subject distance based on (i) the position of the object in the first image, (ii) the position of the object in the second image, (iii) the opening of the diaphragm section 106 when the first image was captured, and (iv) the opening of the diaphragm section 106 when the second image was captured. In the above description, when the object distance is smaller, the position identifying section 150 can identify the subject distance as a distance corresponding to a position that is closer than a position of an object point for which the imaging lenses 102 can form an image on the image surface.

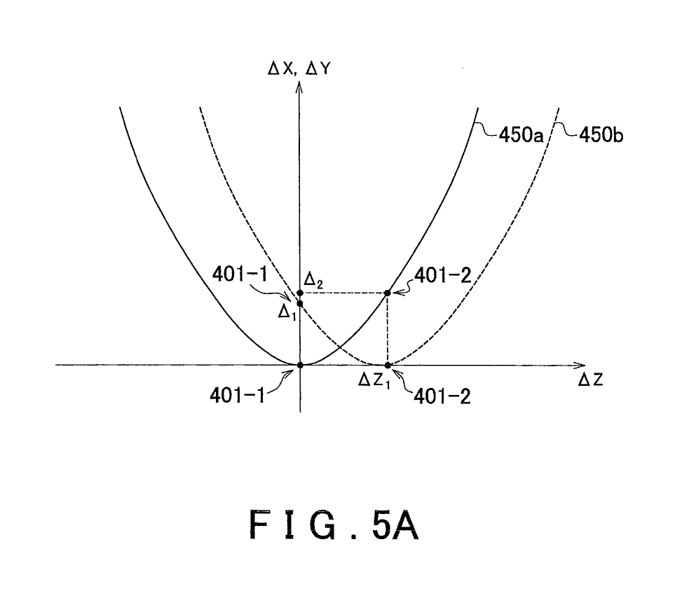

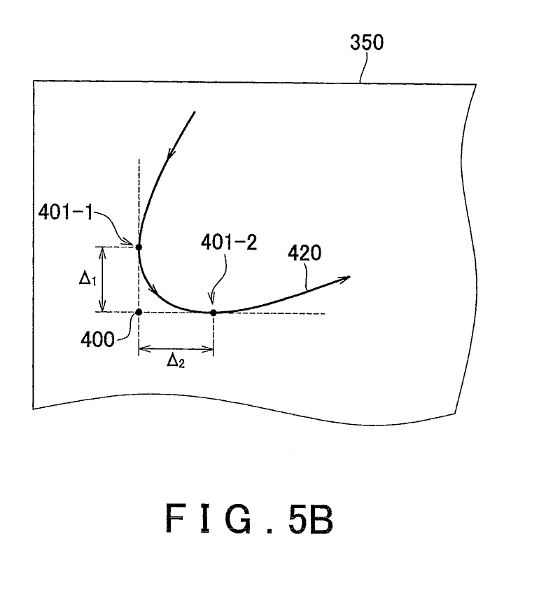

FIG. 5A shows another dependency relation exhibited by the shift amount of the imaging position with respect to the positional shift of the optical system 100. FIG. 5B shows another exemplary shift of the imaging position. The following describes the differences between FIGS. 5A and 5B and FIGS. 4A and 4B.

FIGS. 5A and 5B describe an exemplary positional shift achieved by an optical system 100 having different phase distributions in the x and y directions. More specifically, the phase difference provided by the light modulating section 104 may be adjusted such that the defocus amount d described above differs in the x and y directions. For example, the light modulating section 104 may change the imaging position of the light from the object point through the optical system 100 by applying, to the light from the object point, a phase difference having a distribution differing in mutually perpendicular directions.

With reference to FIG. 5A, when the image 350 captured by the optical system 100 is captured while the control section 120 controls the diaphragm section 106 to have the minimum opening, the light from a certain object point focuses at the position 400 in the image 350.

In FIG. 5A, the line 450a represents the dependency of the positional shift amount Δx in the x-direction on Δz, and the line 450b represents the dependency of the positional shift amount Δy in the y-direction on Δz. Since the imaging position differs in the in the x and y directions, as described above, the lines 450a and 450b are shifted according to the deviation of the imaging position. Therefore, the positional sift amount exhibits different changes in the x and y directions according to Δz, which is different from the example described in relation to FIGS. 4A and 4B.

With reference to the line 450a of FIG. 5, when the control section 120 controls Δz to have a value of 0, the positional shift amount Δx becomes 0 and the positional shift amount Δy becomes 1. In this case, the light from the object point forms an image at the position 401-1 shown in FIG. 5B. When the control section 120 controls Δz to have a value of Δzᵢ, the positional shift amount Δx becomes 2 and the positional shift amount Δy becomes 0. In this case, the light from the object point forms an image at the position 401-2 shown in FIG. 5B.

When the defocus amount in the x-direction is 0, the defocus amount d in the y-direction is not 0. Accordingly, as shown in FIG. 5B, when the diaphragm section 106 is controlled to have the maximum opening, the light from the object point forms a blurred image at the position 401-1, which is shifted from the position 400 in the y-direction by a value Δ₁ according to the defocus amount in the y-direction. On the other hand, when the defocus amount in the y-direction is 0, the defocus amount in the x-direction is not 0. In this case, the light from the object point forms a blurred image at the position 401-2, which is shifted from the position 400 in the x-direction by a value Δ₂ according to the defocus amount in the x-direction. In this way, the light from the object point forms a blurred image at a position on the trajectory 420 according to the defocus amount.

In this way, the positional shift depends on the defocus amount in the x-direction and the y-direction. Accordingly, the position identifying section 150 can identify the defocus amount in the x-direction and the defocus amount in the y-direction based on the shift amount in the x-direction and the shift amount in the y-direction. The position identifying section 150 can then identify the subject distance based on the identified defocus amounts in the x-direction and the y-direction. As described in relation to FIGS. 4A and 4B, the optical system 100 described in relation to FIGS. 5A and 5B can also calculate the subject distance by changing the imaging position and capturing a plurality of images. More specifically, in the same manner as described in relation to FIGS. 4A and 4B, the optical system 100 can calculate the subject distance by storing in advance a function for the subject distance having, as variables, a difference in Δz and a difference in positional shift Δ.

In this way, the position identifying section 150 can identify the subject distance based on the 2-dimensional position of the object in a first image and in a second image. In comparison to the optical system 100 described in relation to FIGS. 4A and 4B, the optical system 100 described in relation to FIGS. 5A and 5B has a position identifying section 150 that can identify whether the subject is at a position that is closer to or further from the optical system 100 than a position of an object point for which the imaging lenses 102 can form an image on the image surface, based on the 2-dimensional position of the object in a first image and in a second image.

By using the technique of calculating the distance by changing the imaging position and capturing multiple images, from among the distance calculation methods described in relation to FIGS. 4A to 5B, the optical system 100 can capture first and second images at different imaging positions and identify the distance from the position of an object in the first image to the position of the same object in the second image. As a result, the optical system 100 can calculate the object position from a bright image, and can therefore increase the accuracy of the object distance calculation and the subject distance calculation.

As described in relation to FIGS. 4A and 4B, when the light modulating section 104 causes a phase distribution that is substantially the same in the x-direction and the y-direction, the defocus amount changes according to the position of the optical system 100, and therefore the object position changes between the first image and the second image. For example, if the object captured at the position 301-1 in the first image is captured at the position 301-2 in the second image, the position identifying section 150 can identify the distance to the subject based on the difference between the position 301-1 and the position 301-2. For example, the position identifying section 150 may calculate the distance to the subject based on the difference in the x-coordinate between the position 301-1 and the position 301-2 or based on the difference in the y-coordinate between the position 301-1 and the position 301-2.

As described in relation to FIGS. 5A and 5B, even if the light modulating section 104 causes a phase distribution that is different in the x-direction and the y-direction, the defocus amount changes according to the position of the optical system 100, and therefore the object position changes between the first image and the second image. For example, if the object captured at the position 401-1 in the first image is captured at the position 401-2 in the second image, the position identifying section 150 can identify the distance to the subject based on the difference between the respective coordinate values of the position 401-1 and the position 401-2.

As described above, the control section 120 controls the defocus amount by controlling the imaging position. The position identifying section 150 can then identify the subject distance based on (i) the position of the object in the first image and in the second image and (ii) the imaging position when the first image was captured and when the second image was captured. The position identifying section 150 stores the subject distance in association with the position of the object and the imaging position of the imaging lenses 102. The position identifying section 150 can then identify a stored subject distance based on the corresponding imaging positions during capturing of the first image and the second image.

In the distance calculation methods described above, the position identifying section 150 may calculate the defocus amount for each of a plurality of image regions, based on the difference in the object position. For example, the position identifying section 150 may store the dependency of the difference in the object position on the defocus amount for each image region. The position identifying section 150 may calculate the defocus amount for each image region based on the stored dependency and the difference in the object position. In this way, the position identifying section 150 can reference the imaging characteristics according to the image height of the optical system 100 to identify the subject distance with a higher degree of accuracy.

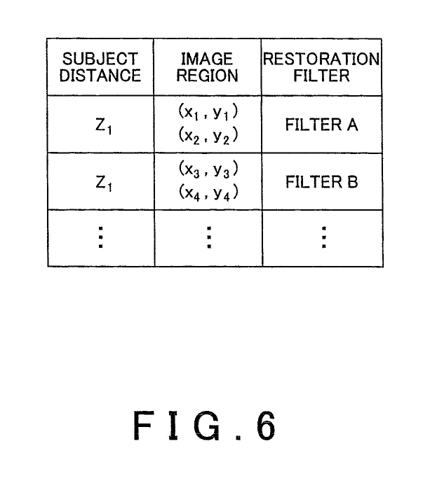

FIG. 6 is a data table showing an example of data stored by the image processing parameter storing section 188. The image processing parameter storing section 188 stores restoration filters in association with the subject distance and the image region.

Each image region represents a region in the image that is a target for restoration. If the image regions are rectangular, the information identifying the image regions may indicate the coordinates of the corners of each rectangle, for example. If the image regions are not rectangular, the information identifying the image regions may be vector information indicating the outline of the regions, for example.

The restoration filters are an example of image processing parameters, and may be exemplified as deconvolution filters that cancel out the blur caused by the light modulating section 104. These deconvolution filters may be exemplified as filters that perform an inverse conversion of the optical transfer function of the optical system 100 to restore the blurred image of the optical system 100 to a point image, or as digital filters or the like based on an inverse filtering technique.

The image processing section 180 selects a restoration filter that corresponds to the image region stored by the image processing parameter storing section 188 in association with the subject distance identified by the position identifying section 150. The image processing section 180 then restores an image signal of each image region using the restoration filter corresponding to the image region.

As described above, the image processing parameter storing section 188 stores a restoration filter for each image region, and therefore, the image processing section 180 can apply a correction process according to the image height to the image generated by the captured image generating section 172. Accordingly, the image processing section 180 can use an appropriate restoration filter to restore the blurred subject image, and can decrease the intensity of artifacts caused by the correction process.

The above description used phase plates having various curves as an example of the light modulating section 104, but the light modulating section 104 can change the wavefront using various other means. For example, the light modulating section 104 may be an optical element with changeable refraction, such as a refraction distribution wavefront modulating optical element, an optical element with a thickness and refraction that changes according to a coating applied to the lens surface, or a liquid crystal element that can modulate the phase distribution of the light, such as a liquid crystal space phase modulating element.

The image of the present embodiment may be a constituent image used as part of a moving image. This moving image constituent image can be exemplified as a frame image. The image processing section 180 can apply the image processing described above to each of the plurality of constituent images in the moving image.

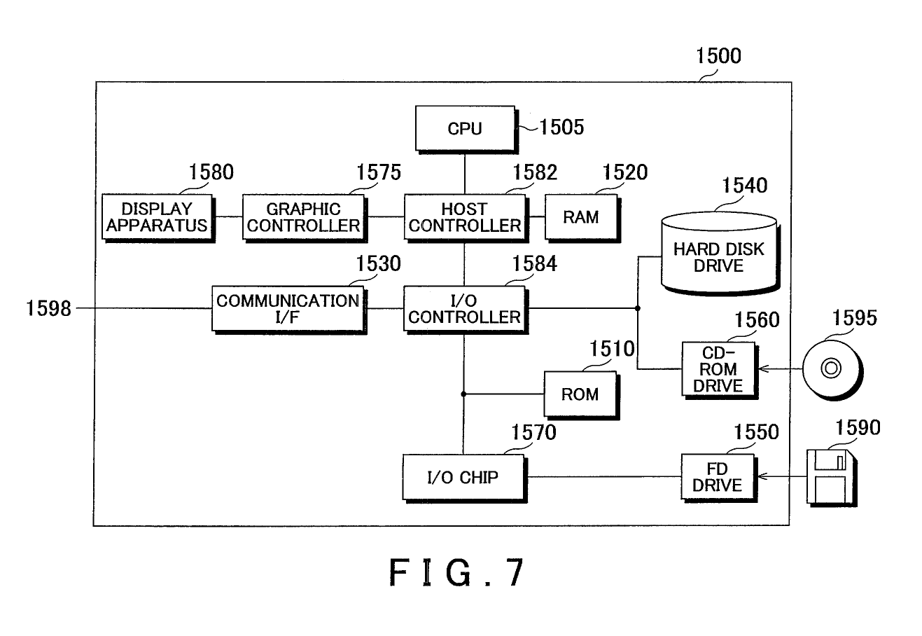

FIG. 7 shows an exemplary hardware configuration of a hardware configuration of a computer 1500 functioning as the image capturing apparatus 110. An electronic information processing apparatus, such as the computer 1500 described in relation to FIG. 7, can function as the image capturing apparatus 110.

The computer 1500 is provided with a CPU peripheral section that includes a CPU 1505, a RAM 1520, a graphic controller 1575, and a display apparatus 1580 connected to each other by a host controller 1582; an input/output section that includes a communication interface 1530, a hard disk drive 1540, and a CD-ROM drive 1560, all of which are connected to the host controller 1582 by an input/output controller 1584; and a legacy input/output section that includes a ROM 1510, a flexible disk drive 1550, and an input/output chip 1570, all of which are connected to the input/output controller 1584.

The host controller 1582 is connected to the RAM 1520 and is also connected to the CPU 1505 and graphic controller 1575 accessing the RAM 1520 at a high transfer rate. The CPU 1505 operates to control each section based on programs stored in the ROM 1510 and the RAM 1520. The graphic controller 1575 acquires image data generated by the CPU 1505 or the like on a frame buffer disposed inside the RAM 1520 and displays the image data in the display apparatus 1580. In addition, the graphic controller 1575 may internally include the frame buffer storing the image data generated by the CPU 1505 or the like.

The input/output controller 1584 connects the hard disk drive 1540, the communication interface 1530 serving as a relatively high speed input/output apparatus, and the CD-ROM drive 1560 to the host controller 1582. The hard disk drive 1540 stores the programs and data used by the CPU 1505. The communication interface 1530 is connected to a network communication apparatus 1598 and receives the programs or the data. The CD-ROM drive 1560 reads the programs and data from a CD-ROM 1595 and provides the read information to the hard disk drive 1540 and the communication interface 1530 via the RAM 1520.

Furthermore, the input/output controller 1584 is connected to the ROM 1510, and is also connected to the flexible disk drive 1550 and the input/output chip 1570 serving as a relatively high speed input/output apparatus. The ROM 1510 stores a boot program performed when the computer 1500 starts up, a program relying on the hardware of the computer 1500, and the like. The flexible disk drive 1550 reads programs or data from a flexible disk 1590 and supplies the read information to the hard disk drive 1540 and the communication interface 1530 via the RAM 1520. The input/output chip 1570 connects the flexible disk drive 1550 to each of the input/output apparatuses via, for example, a parallel port, a serial port, a keyboard port, a mouse port, or the like.

The programs performed by the CPU 1505 are stored on a recording medium such as the flexible disk 1590, the CD-ROM 1595, or an IC card and are provided by the user. The programs stored on the recording medium may be compressed or uncompressed. The programs are installed on the hard disk drive 1540 from the recording medium, are read by the RAM 1520, and are performed by the CPU 1505. The programs performed by the CPU 1505 cause the computer 1500 to function as the light receiving section 170, the captured image generating section 172, the image storing section 174, the image acquiring section 130, the image processing section 180, the image processing parameter storing section 188, the position identifying section 150, the output section 190, and the control section 120 described in relation to FIGS. 1 to 6.

The programs shown above may be stored in an external storage medium. In addition to the flexible disk 1590 and the CD-ROM 1595, an optical recording medium such as a DVD or PD, a magnetooptical medium such as an MD, a tape medium, a semiconductor memory such as an IC card, or the like can be used as the recording medium. Furthermore, a storage apparatus such as a hard disk or a RAM disposed in a server system connected to the Internet or a specialized communication network may be used as the storage medium and the programs may be provided to the computer 1500 via the network.

While the embodiments of the present invention have been described, the technical scope of the invention is not limited to the above described embodiments. It is apparent to persons skilled in the art that various alterations and improvements can be added to the above-described embodiments. It is also apparent from the scope of the claims that the embodiments added with such alterations or improvements can be included in the technical scope of the invention.

What is claimed is:

1. An image capturing apparatus comprising:
an image capturing section;
an optical system that has an optical transfer characteristic that remains substantially constant with regard to distance to an object point due to modulation of a wavefront of light from the object point, and that modulates the wavefront of the light from the object point to have a different slope according to the distance to the object point;
a control section that controls an imaging characteristic of the optical system by controlling an optical characteristic of the optical system; and
a position identifying section that identifies a subject distance, which is distance to a subject, based on a position of an object representing the same subject in a first image and a second image, which are respectively captured when the control section controls optical system to have different imaging characteristics.

2. The image capturing apparatus according to claim 1, wherein
the optical system causes the wavefront of the light from the object point to have substantially the same spread regardless of the distance to the object point by modulating the wavefront of the light from the object point.

3. The image capturing apparatus according to claim 1, wherein
the optical system causes a phase distribution of the light from the object point to have substantially the same spread regardless of the distance to the object point by approximating the phase distribution with a polynomial function of an order greater than two corresponding to a position relative to an optical axis.

4. The image capturing apparatus according to claim 3, wherein
the optical system approximates the phase distribution of the light from the object point with a polynomial function including a second-order term that expresses the phase distribution according to the distance to the object point.

5. The image capturing apparatus according to claim 4, wherein
the optical system approximates the phase distribution of the light from the object point with a polynomial function including a second-order term corresponding to the distance to the object point and an odd-order term of third-order or higher.

6. The image capturing apparatus according to claim 5, wherein
the optical system approximates the phase distribution of the light from the object point with a polynomial function including the second-order term corresponding to the distance to the object point and a third-order term.

7. The image capturing apparatus according to claim 5, wherein
the optical system includes:
an imaging lens that focuses light; and
a light modulating section that modulates a phase of light passing therethrough, wherein
the optical system approximates the phase distribution of the light from the object point with a polynomial function including a second-order term corresponding to the imaging lens and an odd-order term of the third-order or higher corresponding to the phase modulation by the light modulating section.

8. The image capturing apparatus according to claim 7, wherein
the control section controls the imaging characteristic by controlling the light modulating section to be inserted in an optical path of the imaging lens and to be removed from the optical path of the imaging lens.

9. The image capturing apparatus according to claim 7, wherein
the optical system includes a diaphragm section that restricts light from the subject, and
the control section controls the imaging characteristic by controlling a degree to which the diaphragm section is opened.

10. The image capturing apparatus according to claim 9, wherein
the control section controls the imaging characteristic by controlling the diaphragm section to be opened to a degree at which an effect of the phase modulation by the light modulating section and an aberration caused by the imaging lens is less than or equal to a predetermined value, and to a degree at which the effect is greater than the predetermined value.

11. The image capturing apparatus according to claim 9, wherein
the position identifying section identifies the subject distance based on object distance, which is distance between a position of the object in the first image and a position of the object in the second image.

12. The image capturing apparatus according to claim 11, wherein
when the object distance is smaller, the position identifying section identifies the subject distance as being a distance corresponding to a position closer to an object point for which the imaging lens can form an image on an image capturing surface of the image capturing section.

13. The image capturing apparatus according to claim 12, further comprising an image processing section that corrects the second image according to the optical transfer characteristic of the optical system at the time of capturing the second image, wherein
the position identifying section identifies the subject distance based on positions of the object representing the same subject in the second image and in the corrected image obtained by the image processing section correcting the second image.

14. The image capturing apparatus according to claim 9, wherein
the position identifying section identifies the subject distance based on (i) the position of the object in the first image, (ii) the position of the object in the second image, (iii) the degree to which the diaphragm section is opened when the first image is captured by the image capturing section, and (iv) the degree to which the diaphragm section is opened when the second image is captured by the image capturing section.

15. The image capturing apparatus according to claim 7, wherein
the light modulating section applies, to the light from the object point, a phase difference with distributions that differ in directions orthogonal to each other, such that the optical system creates different imaging positions for the light from the object point, and
the position identifying section identifies the subject distance based on a two-dimensional position of the object in the first image and in the second image.

16. The image capturing apparatus according to claim 15, wherein
the position identifying section identifies whether the subject is at a position closer to the optical system than a position of an object point for which the imaging lens can form an image on an image capturing surface of the image capturing section.

17. The image capturing apparatus according to claim 7, wherein
the control section controls the imaging characteristic by controlling the imaging position of the imaging lens, and
the position identifying section identifies the subject distance based on (i) positions of the object in the first image and in the second image and (ii) the respective imaging positions during capturing of the first image and of the second image.

18. The image capturing apparatus according to claim 17, wherein
the position identifying section stores the subject distance corresponding to a position at which the subject captured as the object is to exist, in association with the imaging position of the imaging lens and the position of the object, and
the position identifying section identifies the subject distance stored in association with imaging positions during capturing of the first image and the second image.

19. The image capturing apparatus according to claim 1, wherein
the optical system has a shape that is non-rotationally symmetric with respect to an optical axis.

20. An image capturing method comprising:
capturing an image through an optical system that has an optical transfer characteristic that remains substantially constant with regard to distance to an object point due to modulation of a wavefront of light from the object point, and that modulates the wavefront of the light from the object point to have a different slope according to the distance to the object point;
controlling an imaging characteristic of the optical system by controlling an optical characteristic of the optical system; and
identifying a subject distance, which is distance to a subject, based on a position of an object representing the same subject in a first image and in a second image, which are respectively captured when the control section controls optical system to have different imaging characteristics.

21. A computer readable medium storing thereon a program for use by an image capturing apparatus, the program causing the computer to function as:
an image capturing section capturing an image through an optical system that has an optical transfer characteristic that remains substantially constant with regard to distance to an object point due to modulation of a wavefront of light from the object point, and that modulates the wavefront of the light from the object point to have a different slope according to the distance to the object point;
a control section that controls an imaging characteristic of the optical system by controlling an optical characteristic of the optical system; and
a position identifying section that identifies a subject distance, which is distance to a subject, based on a position of an object representing the same subject in a first image and a second image, which are respectively captured when the control section controls optical system to have different imaging characteristics.
